(19) United States
(12) Patent Application Publication
(10) Pub. No.: US 2007/0174638 A1
(43) Pub. Date: Jul. 26, 2007

(54) Method used for digital right management of system-on-chip IP by making use of system platform

(75) Inventors: Yu-Cheng Fan, Hsinchu (TW); Hen-Wai Tsao, Taipei City (TW)

Correspondence Address: BIRCH STEWART KOLASCH & BIRCH, PO BOX 747, FALLS CHURCH, VA, 22040-0747, US

(73) Assignee: National Taiwan University

(21) Appl. No.: 11/335,625

(22) Filed: Jan. 20, 2006

(51) Int. Cl. G06F 12/14

(52) U.S. Cl. 713/193

(57) ABSTRACT

A method used for digital right management (DRM) of system-on-chip (SOC) IP by making use of a system platform, which provides an encryption & protection mechanism created by incorporating the IP designer, the IP supplier, the wafer manufacturer, the customer, and the electronic design automation (EDA) tool, thus establishing an integral and efficient SOC IP management and protection platform. In this method, the IP core hardware program codes are protected through incorporating an IP identification code (comprising a general ID code and a security ID code) into the behavior design level of the IP core hardware program codes and utilizing a public key encryption protection of the SOC IP. Therefore, through such a kind of encryption, the customer is not able to perceive the existence of the IP identification code. In addition, a SOC IP fingerprint is included in the security ID code of the IP identification code, thus the customer engaged in the illegal distribution of copies of IP can be traced through the SOC IP fingerprint.

### BACKGROUND OF THE INVENTION

1. Field of the Invention

The present invention relates to a method used for digital right management (DRM) of system-on-chip (SOC) IP by making use of a system platform, and in particular to a method used for digital right management of system-on-chip (SOC) IP in tracing the source of IP by making use of a IP identification code and a (SOC) IP DRM system platform.

2. The Prior Arts

Nowadays, the tendency of IC design is toward the development of and manufacturing of “System on Chip” (SOC). Therefore, the concept of SOC IP is proposed and emphasized. As such, the manufacturing of the system-on-chip can be realized through incorporating a pre-designed and tested IP core into the chip. Thus, quite a lot of IP modules can be utilized repeatedly, and the various parts of a system-on-chip may be designed and produced by different manufacturers, and then be put together to produce a final product of system-on-chip, so that the design and manufacturing of the system-on-chip does not have to be done entirely by a single designer and/or manufacturer.

However, in case that such IPs are incorporated into ICs without proper approval or authorization, then after the process of synthesis and P&R, it is very difficult to distinguish from the photograph or layout that which parts of the IC belong to the unauthorized IPs.

According to an unofficial statistical report, the annual loss of revenue of the information industry due to this kind of unauthorized use of IP core can reach as high as US $500 million. Quite often, many IC Design Houses file legal litigations recriminating each other in order to protect their own rights. However, such legal litigations usually may not produce any concrete and definite results due to lack of direct and substantial evidence.

In order to provide the Intellectual Property Right of the IC designers with effective and sufficient protection, so that the designers are more willing to be engaged in the design and development of IP core, thus the entire IC design industry may progress at a faster pace. Therefore, there does exist a need in the industry for a management means that can be utilized to trace the flow of IP cores effectively, so that in utilization of the electronic design automation (EDA) tool, it will not be subjected to overly excessive restrictions.

The concept of digital right management (DRM) is originally used in the sphere of multi-media, and is mainly utilized to protect and manage the digital right of the owner of the multi-media products. A thorough and complete digital right management may effectively achieve the purpose of counterfeiting and intellectual right verification and protection. However, at present, such a kind of technology of digital right management (DRM) of system-on-chip (SOC) IP simply does not exist, nor does it exist a security mechanism for the SOC IP. Therefore, the research and development of a system platform and method for the DRM of SOC IP to provide sufficient protection for the designers and suppliers of SOC IP is a most urgent and important task in this field.

### SUMMARY OF THE INVENTION

In view of the shortcomings and drawbacks of the prior art, the objective of the present invention is to provide a system platform and method used for digital right management (DRM) of system-on-chip (SOC) IP, which can be used to effectively control and trace the flow of IPs through embedding the IP identification code into the IP core by making use of the public key and through executing the origin verification procedure by making use of network environment information, thus effectively tracking the company or individual for the illegal distribution of IPs, and achieving the objective of protecting the SOC IP. Meanwhile, since most of the protection procedures of this method are carried out without changing or interrupting the existing tools or equipments, thus its market acceptability can be raised significantly.

To achieve the above-mentioned objective, the method used for managing the SOC IP is realized through establishing a IP identification code composed of a General ID code and a Security ID code, and embedding them into the behavior design level of the IP hardware program code, thus providing encryption protection to IP core by making use of the public key code of the present invention. Since the user or customer does not perceive the existence of the IP identification code in the IP, thus if the IP core is illegally distributed to outside, the identity of the company illegally distributing the IP code can be identified through the IP identification code.

Upon adding the IP identification code, public key and private key into the IP core, then in the security platform composed of the IP supplier, electronic design automation (EDA) supplier, customer, wafer manufacturer, and IC designer, the network environment information and the IP identification code may be utilized to as a verification basis to aide the customer in proceeding with the design and simulation procedures without interfering the EDA software tools by making use of the encoded IP hardware program codes, IP documents, the simulation/verification model of each stage design level, simulation patterns and test patterns.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of a system platform used for digital right management (DRM) of system-on-chip (SOC) IP according to an embodiment of the present invention;

FIG. 2A is a schematic diagram of a general ID code utilized in the present invention;

FIG. 2B is a schematic diagram of a security ID code utilized in the present invention;

FIG. 3 is a schematic diagram of a security platform established by the transactions between/among the IP supplier, the IP designer, the EDA software tool supplier, and the customer according to an embodiment of the present invention;.

FIG. 4 a schematic diagram indicating the public key encoding procedure of the present invention;

FIGS. 5A & 5B are the schematic diagrams of the conversion tables utilized in the public key conversion procedure according to an embodiment of the present invention;

FIG. 6 is a schematic diagram of the private key encoding procedure according to an embodiment of the present invention;

FIG. 7 is a schematic diagram of the conversion tables utilized in the private key conversion procedure according to an embodiment of the present invention;

FIG. 8 is a schematic diagram of the decoding procedure according to an embodiment of the present invention;

FIG. 9 is a schematic diagram of an IP protection platform according to an embodiment of the present invention;

FIG. 10 is a schematic diagram of a black box simulation procedure of the present invention; and

FIGS. 11A & 11B are the flowcharts of the steps of a method in realizing the IP codes protection through the system platform of the present invention.

### DETAILED DESCRIPTION OF THE PREFERRED EMBODIMENT

The purpose, construction, features, and functions of the present invention can be appreciated and understood more thoroughly through the following detailed description with reference to the attached drawings.

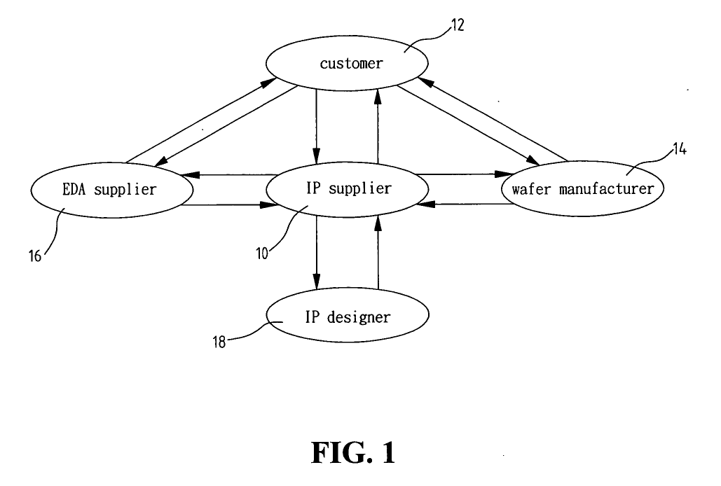

Firstly, referring to FIG. 1 for a schematic diagram of a system platform used for digital right management (DRM) of system-on-chip (SOC) IP according to an embodiment of the present invention. As shown in FIG. 1, in the DRM system platform of SOC IP, the electronic design automation (EDA) software tool supplier 16 has negotiated and set in advance the protection means (IP identification code, public key, private key, and network environment information) with IP supplier 10 and IP designer 18, thus providing the EDA tools to the customer 12. And finally, the IP and its the layout required by the customer 12 are sent by the IP supplier to the wafer manufacturer 14 for realizing the actual physical wiring. The public key encoding procedure is mainly defined by the EDA software supplier, and the private key encoding procedure is mainly defined by IP supplier 10. In utilizing the EDA tools, the customer 12 usually does not feel too much difference as he/she did usually in the past, and will not even perceive the existence of the method of managing the SOC IP. In the following, the details of utilizing the EDA tool having the added management mechanism of the present invention will be described relative to the IP identification code, public key, private key and the customer.

The reason that the method of managing the SOC IP of the present invention can be used in achieving the objective of tracking the particular company or individual that is involved in illegally distributing the IP cores is that, before being provided to the customer 12 by the IP supplier 10, the IP core is embedded with the IP identification code composed of General ID code and Security ID code in the behavior design level of its hardware program code. Since the General ID code is used to identify the IP supplier 10, and the Security ID code is used to identify the customer 12. Thus, if the IP is illegally distributed, the IP identification code can by used to check and verify that which particular company or individual (customer 12) is involved in the illegal distribution of the IP core of a particular IP supplier 10

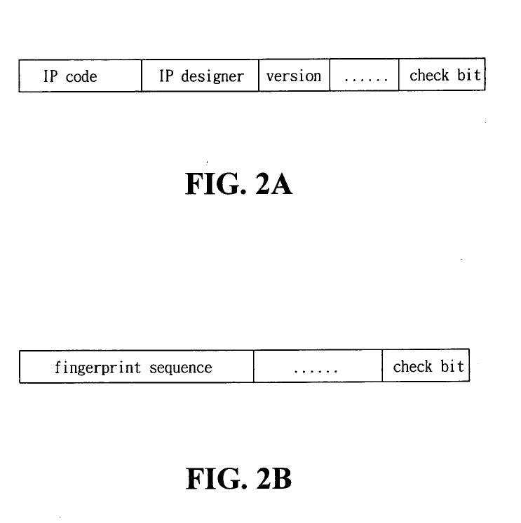

Next, referring to FIGS. 2A & 2B for schematic diagrams indicating the respective layout of the General ID code and the Security ID code. As shown in FIG. 2A, the General ID code is composed at least of an IP number, an IP design company, a version number, a manufacturing process number, and a check bit. In addition, as shown in FIG. 2B, the security ID code is composed at least of a fingerprinting sequence and a check bit.

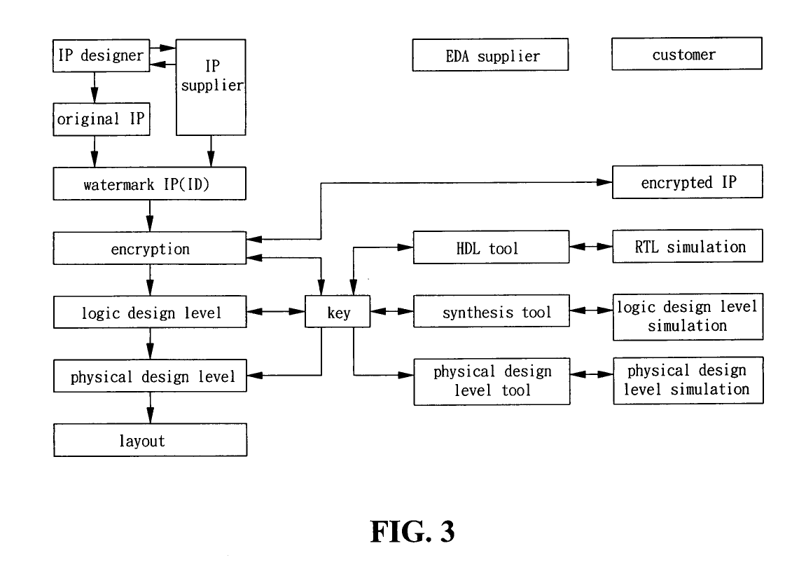

Then, referring to FIG. 3, which shows a schematic diagram of a security platform established by the transactions between/among the IP supplier, IP designer, EDA software tool supplier, and customer. In short, in this particular security platform, the ready made IP is provided by the IP designer 18 to the IP supplier 10. Next, the IP identification code (namely, the General ID code and the Security ID code) is added into IP according to the contract/agreement between the IP designer 18 and the IP supplier 10. Then, the behavior design level program codes are converted into the logic design level program codes by the IP designer 18 through a synthesis software. Subsequently, the logic design level program codes are converted into the physical design level codes by making use of an automatic wiring layout software, thus further realizing the circuit layout and DRC and ERC verifications.

More specifically, in order to achieve embedding the IP identification code into the behavior design level of the IP core hardware program code, a further encryption protection mechanism is required, namely, a public key encryption procedure and a private key encryption procedure.

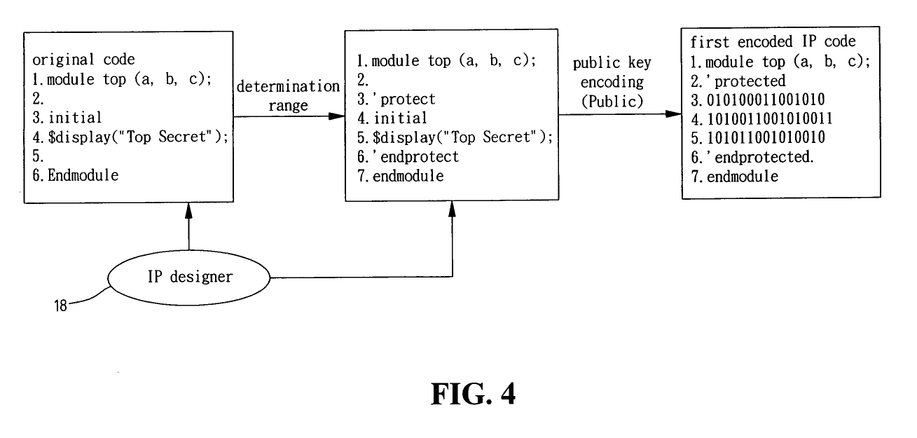

Subsequently, referring to FIG. 4 for a schematic diagram indicating the steps of a public key encryption procedure. As shown in FIG. 4, upon entering the IP identification code into the object code of IP, the EDA software tool designed by the EDA supplier is used to interpret the ID code and mark the range needs to be encrypted and protected with ‘protect’ and ‘endprotect’. Then, the public key prepared by the EDA supplier in advance is used to proceed with the encoding operation for the contents within the range, thus generating the first encoded IP codes. In general, the public key encoding operation is achieved through a substitution sequence procedure and an alternate sequence procedure.

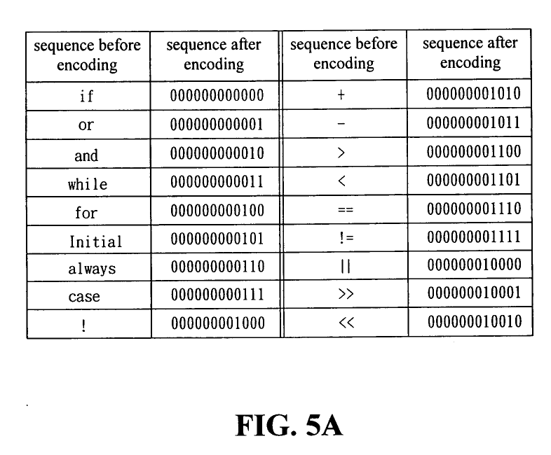

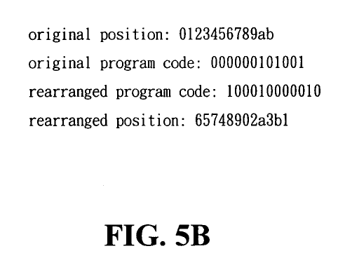

In this respect, referring to FIGS. 5A & 5B for the schematic diagrams of the conversion tables utilized in the public key conversion operation according to an embodiment of the invention. For instance, as shown in FIG. 5A, the code number sequence “000000000000” is used to replace and represent “if” in the hardware description language in the coding range between “protect” and “endprotect” as shown in FIG. 4 by means of the substitution sequence procedure, then the converted codes are subject to further encoding according to the alternate sequence procedure as shown in FIG. 5B. However, it should be noted that, the public key encoding operation disclosed in the present invention is not limited to the operation means as shown in FIGS.5A & 5B. In practice, any effective coding and encoding means can be utilized in the public key encoding operation.

The above-mentioned public key encoding operation as shown in FIGS. 5A & 5B is a kind of semi-open encoding method. However, an ill-intended person may still be able to get the decryption means from the EDA supplier to break the codes, therefore, the first encoded IP codes must subject to further encoding utilizing the private key provided by the IP supplier 10.

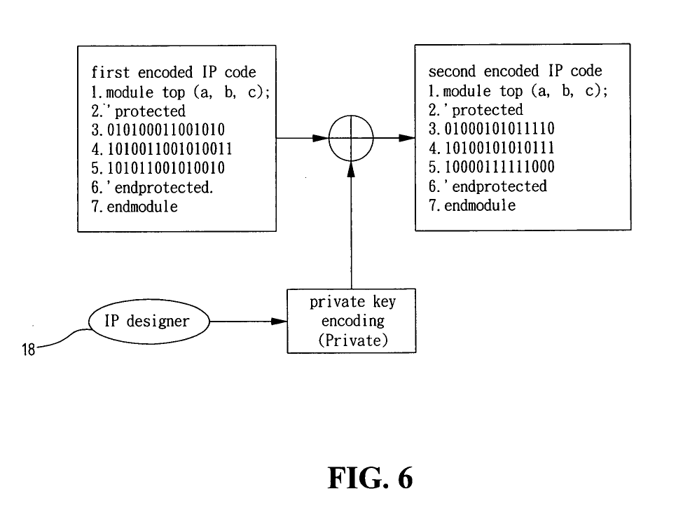

Then, referring to FIG. 6 for a schematic diagram of the private key encoding procedure according to an embodiment of the invention. As shown in FIG. 6, the first encoded IP codes shown in FIG. 4 are further encoded to the second encoded IP codes by an IP designer 18 through the private key having at least 500 bits with each bit as a binary bit.

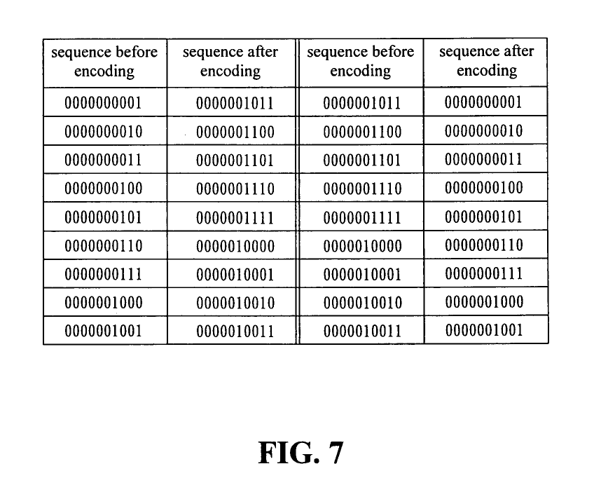

Moreover, referring to FIG.7 for a schematic diagram of the codes corresponding tables utilized in the private key conversion operation according to an embodiment of the invention. As shown in FIG. 7, in the respective items of the private key, 10 bits are grouped as a sequence, so that the first encoded IP codes of the hardware description language are rearranged and converted into the second encoded IP codes.

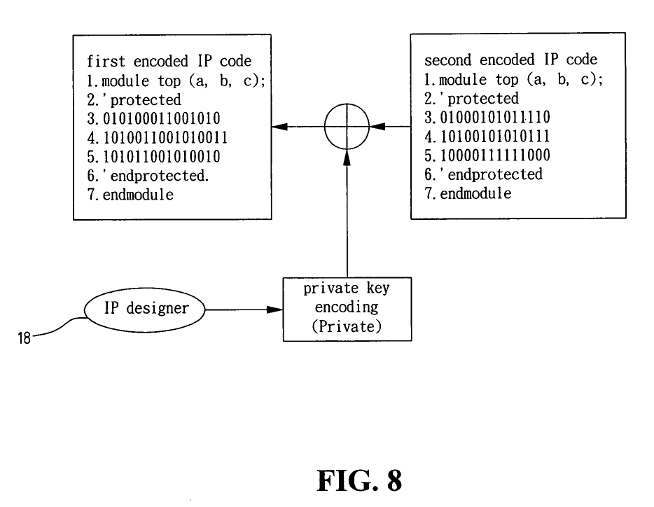

Furthermore, referring to FIG. 8 for a schematic diagram of the decoding procedure according to an embodiment of the invention. As shown in FIG. 8, the public key and private key may be utilized by an IP designer desiring to trace and know just which company or individual at the customer 12 is responsible for the illegal distribution of a particular IP supplied by a particular IP supplier 10, so that the second encoded IP codes may be decoded to the first encoded IP codes according to the procedure shown in FIG. 8. And then the operation procedures shown in FIG. 4 to FIG. 6 are executed in a reverse order to decode the encoded IP codes. Upon completion of the decryption of codes, the identity of the company or individual involving in the illegal distribution of IPs through the General ID code of the IP supplier and the Security ID code of the Customer.

At this stage, to the IP designer 18, the second encoded IP codes may further be converted into the logic design level program codes, then the logic design level program codes are converted into the physical design level program codes. And finally, the IC layout, DRC and ERC verifications may be realized through the physical design level program codes. Upon finishing the design of a particular stage, the above-mentioned method may be utilized by the IP designer 18, the IP supplier 10 to provide the protection of IP.

In the afore-mentioned procedure, the IPs are fully protected once the IP identification code is embedded into the behavior design level of IP core and the encoding process is completed, thus they can be distributed to the customer just as the ordinary IPs. However, for better and enhanced protection of IP, another IP protection platform is provided, the details of which are described as follows

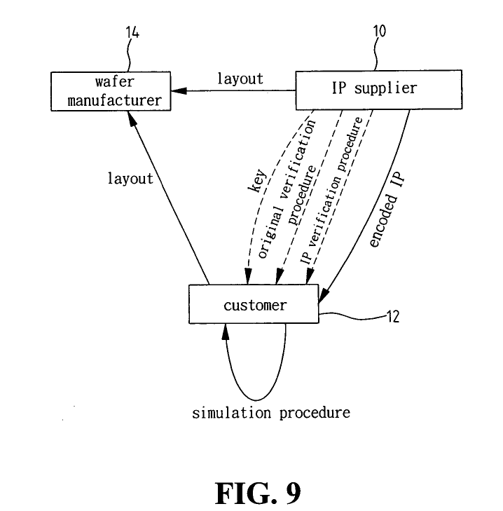

Firstly, referring to FIG. 9 for a schematic diagram of an IP protection platform according to an embodiment of the invention. As shown in FIG. 9, the design level model can be classified into a register transfer level (RTL), a logic design level, and a physical design level. As such, the protection platform is utilized to transmit the encrypted IP codes to the customer 12 as shown in FIG. 9 for the various design levels and with the knowledge of the customer 12, while transmitting the key to the customer without the knowledge of the customer, thus proceeding with the origin verification procedure, and proceeding with the IP identification procedure.

More specifically, the customer 12 may request the IP supplier 10 to provide the respective second encoded IP code, IP documents, simulation/verification model for the respective design levels, and simulation signal and test signal to the customer 12.

Next, the network environment information of the customer 12 is utilized to proceed with the origin verification procedure. The network environment information is composed of at least a network card MAC address and an IP address, and is given to IP supplier 10 by the customer 12 in advance.

Upon passing the origin verification procedure and certifying that the IP identification code contained in the second encoded IP code is compatible with that of IP supplier 10 and customer 12, then provide the key to the customer 12.

Then, incorporate the IP codes into the system-on-chip of the customer 12 based on the IP documents and proceed with the verification procedure through utilizing the simulation/verification model.

In case that the design level is a register transfer level (RTL) or logic design level, then upon finishing the examination procedure of simulation and verification, the customer 12 will provide the IP supplier 10 with the hardware program codes for that particular design level.

However, in case that the design level is a physical design level, then upon finishing the procedures of simulation and examination, the customer 12 will transmit the layouts for that particular design layer to a wafer manufacturer 14 and used in realizing the actual physical wiring. Meanwhile, the IP supplier 10 will provide the decoded IP codes to the wafer manufacturer 14, thus realizing the actual physical wiring of chips.

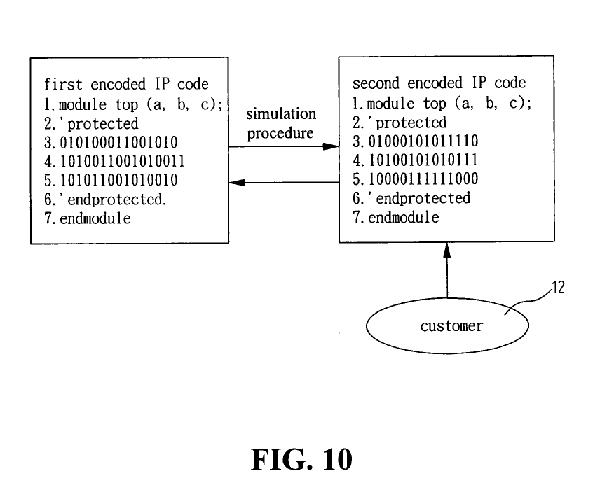

Subsequently, referring to FIG. 10 for a schematic diagram of a black box simulation procedure of the present invention. As shown in FIG. 10, the IP codes are integrated into a system-on-chip of a customer 12 according to an IP document, and are used to proceed with the verification procedure based on the simulation/verification model, thus this particular procedure is called a black-box simulation. As with the case of conventional discrete IC elements, they can be utilized if they are provided with a Data Sheet.

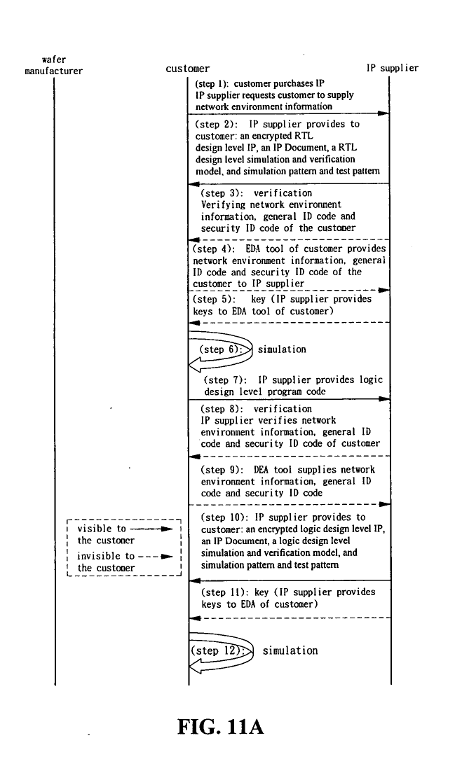

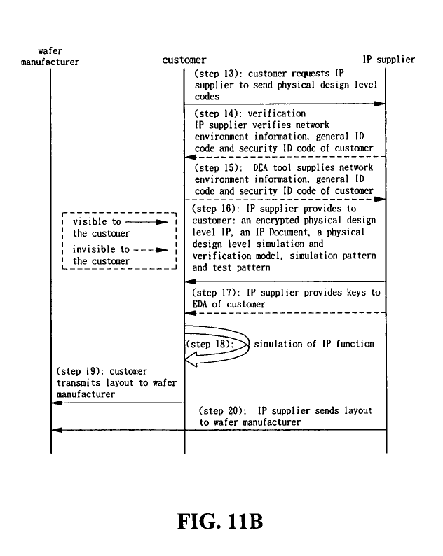

Finally, referring to FIGS. 11A & 11B for the flowcharts of the steps for realizing the IP codes protection through a system platform of the present invention. The details of respective steps are described as follows:

Step 1: when the customer 12 intends to purchase an IP from an IP supplier 10, the customer 12 and the IP supplier 10 will co-sign a transaction contract and a security contract. Usually, the IP supplier 10 will ask the customer 12 to provide the network environment information (for example, LAN card number and Internet Protocol Address).

Step 2: upon signing the contracts, the IP supplier 10 will first provide the customer 12 with: an encrypted RTL design level IP, an IP Document, a RTL design level simulation and verification model, and simulation pattern and test pattern.

Step 3: the IP supplier 10 transmits an identification message via a network to the EDA tool used by the customer 12 to verify the network environment information (LAN card number and Internet Protocol Address) and the IP identification code (the general ID code and the security ID code) contained in the IP codes. In this step, the customer 12 is not able to perceive the proceedings, only the IP supplier 10 and the EDA Tool are aware of the execution of the step.

Step 4: In response, the EDA tool at the customer end 12 provides the IP supplier with the network environment information (LAN card number and Internet Protocol Address) and the IP identification code (the general ID code and the security ID code) as required by the IP supplier 10. Likewise, in this step, the customer 12 is not able to perceive the proceedings, only the IP supplier 10 and the EDA Tool are aware of the execution of the step.

Step 5: In case that the network environment information (LAN card number and Internet Protocol Address) and the IP identification code (the general ID code and the security ID code) are verified as compatible, then the IP supplier 10 provide the EDA Tool at the customer 12 with a set of keys. Similarly, the customer 12 is not able to perceive the proceedings, only the IP supplier 10 and the EDA Tool are aware of the execution of the step.

Step 6: The IPs are incorporated into the system-on-chip by the customer 12 according to the IP document and the simulation and verification model of the RTL design level. The IP function may be simulated and verified through the simulation and verification model of the RTL design level. Thus this kind of verification is called a black-box simulation. As with the case of traditional discrete IC elements, they can be utilized as long as they are provided with a Data Sheet.

Step 7: Upon finishing the simulation and verification of the RTL design level, the customer 12 sends message to the IP supplier 10 via a network requesting the IP supplier 10 to provide the hardware program codes of the logic design level.

Step 8: The IP supplier 10 transmits an identification message via network to the EDA tool used by the customer 12 to verify the network environment information (LAN card number and Internet Protocol Address) of the customer 12 and the IP identification code (the general ID code and the security ID code) contained in the IP codes. In this step, the customer 12 is not able to perceive the proceedings, only the IP supplier 10 and the EDA Tool are aware of the execution of the step.

Step 9: In response, the EDA tool at the customer end 12 provides the network environment information (LAN card number and Internet Protocol Address) and the IP identification code (the general ID code and the security ID code) as required by the IP supplier 10. Likewise, in this step, the customer 12 is not able to perceive the proceedings, only the IP supplier 10 and the EDA Tool are aware of the execution of the step.

Step 10: In case that the network environment information (LAN card number and Internet Protocol Address) and the IP identification code (the general ID code and the security ID code) are verified as compatible, then the IP supplier 10 provides the customer 12 with the encrypted logic design level IP, the IP Document, the simulation and verification model of the logic design level, and simulation pattern and test pattern. In this step, the customer 12 is able to perceive the above proceedings.

Step 11: the IP supplier 10 provides the EDA Tool of the customer 12 with a set of keys. The customer 12 is not able to perceive the proceedings, only the IP supplier 10 and the EDA Tool are aware of the execution of the step.

Step 12: The IPs are incorporated into the system-on-chip by the customer 12 according to the IP document and the simulation and verification model of the logic design level. The IP function may be simulated and verified through the simulation and verification model of the logic design level.

Step 13: Upon finishing the simulation and verification of the logic design level, the customer 12 sends message to the IP supplier 10 via a network requesting the IP supplier 10 to provide the hardware program codes of the physical design level model.

Step 14: the IP supplier 10 transmits an identification message via network to the EDA tool used by the customer 12 to verify the network environment information (LAN card number and Internet Protocol Address) of the customer 12 and the IP identification code (the general ID code and the security ID code) contained in the IP codes. In this step, the customer 12 is not able to perceive the proceedings, only the IP supplier 10 and the EDA Tool are aware of the execution of the step.

Step 15: In response, the EDA tool at the customer end 12 provides the network environment information (LAN card number and Internet Protocol Address) and the IP identification code (the general ID code and the security ID code) as required by the IP supplier 10. Likewise, in this step, the customer 12 is not able to perceive the proceedings, only the IP supplier 10 and the EDA Tool are aware of the execution of the step.

Step 16: In case that the network environment information (LAN card number and Internet Protocol Address) and the IP identification code (the general ID code and the security ID code) are verified as compatible, then the IP supplier 10 provides the customer 12 with the encrypted physical design level IP, the IP Document, the physical design level simulation and verification model, simulation pattern and test pattern. In this step, the customer 12 is able to perceive the above proceedings.

Step 17: The IP supplier 10 provides the EDA Tool of the customer 12 with a set of keys. The customer 12 is not able to perceive the proceedings, only the IP supplier 10 and the EDA Tool are aware of the execution of the step.

Step 18: The IPs are incorporated into the system-on-chip by the customer 12 according to the IP document and the simulation and verification model of the physical design level. The IP function may be simulated and verified through the simulation and verification model of the physical design level.

Step 19: upon finishing the procedures of simulation and verification of the physical design level, the customer 12 transmits the encrypted and finished layout of the physical design level to a wafer manufacturer 14 to be realized in the actual physical wiring.

Step 20: the IP supplier 10 provides the decrypted IP layout to the chip manufacturer 14, thus realizing the actual physical wiring of the chips.

Summing up the above, in the SOC IP management method of the present invention, the IP core is protected by the Public Key through inserting Security ID code into the IP core, and with the Network Environment Information as the verification basis. Upon authorization, through the verification of the Public Key. Security ID code, and the network environment information, not only the IP of behavior design level can be protected, but the IP of the logic design level and physical design level can also be protected. Through the verification process of the Security ID code, the owner and original designer of the IP can be checked and verified without having to open the IC package or the retracing procedure code.

The above detailed description of the preferred embodiment is intended to describe more clearly the characteristics and spirit of the present invention. However, the preferred embodiment disclosed above is not intended to be any restrictions to the scope of the present invention. Conversely, its purpose is to include the various changes and equivalent arrangements which are within the scope of the appended claims.

What is claimed is:

1. A method used for digital right management of system-on-chip (SOC) IP by making use of a system platform, wherein an IP core provided by an IP supplier is incorporated into a system-on-chip at the customer end under the protection of encryption, thus establishing a system design platform for managing and protecting the SOC IP, comprising the following steps:
creating a IP identification code of said IP supplier in possession of said IP codes, said IP identification code is mainly composed of a General ID code related to said IP supplier, and a Security ID code related to the customer end, hereby
representing the owner and serial number of said SOC IP; and
encoding said IP identification code contained in an IP codes through a substitution sequence procedure and an alternate sequence procedure, thus generating a first encoded IP codes.

2. The method used for digital right management of system-on-chip (SOC) IP by making use of a system platform as claimed in claim 1, wherein said General ID code includes at least: an IP number, an IP design number, a version, a manufacturing information and a check bit.

3. The method used for digital right management of system-on-chip (SOC) IP by making use of a system platform as claimed in claim 1, wherein said Security ID code includes at least a fingerprinting sequence and a check bit.

4. The method used for digital right management of system-on-chip (SOC) IP by making use of a system platform as claimed in claim 1, wherein said SOC IP management method further comprising the step of:
encoding the first encoded IP codes into said second encoded IP codes with a private key having at least 500 binary bits.

5. The method used for digital right management of system-on-chip (SOC) IP by making use of a system platform as claimed in claim 1, wherein said SOC IP management method further comprising the steps of:
converting said second encoded IP codes into the logic design level program codes;
converting said logic design level program codes into the physical design level program codes; and
executing a layout procedure according to physical design level program codes.

6. The method used for digital right management of system-on-chip (SOC) IP by making use of a system platform as claimed in claim 1, further comprising the steps of:
requesting said IP supplier to provide the following items to said customer according to the respective design levels: said second encoded IP codes (encoded and corresponding to IP codes of said design level), an IP document, a simulation/verification model corresponding to said design level, a simulation pattern, and a test pattern;
executing an origin verification procedure based on the network environment information of said customer, said network environment information includes at least a network card MAC address and an IP address;
upon going through said origin verification procedure and verifying that said IP identification code contained in said second encoded IP codes are compatible with that of said IP supplier and said customer respectively, then supply a set of keys to said customer; and
incorporating said IP codes into said system-on-chip of said customer according to said IP documents, and executing the verification procedure based on said simulation/verification models.

7. The method used for digital right management of system-on-chip (SOC) IP by making use of a system platform as claimed in claim 6, wherein said design level can be one of the following: register transfer level (RTL), a logic design level, and a physical design level.

8. The method used for digital right management of system-on-chip (SOC) IP by making use of a system platform as claimed in claim 6, wherein in case that said design level is said register transfer level or said logic design level, then upon finishing the simulation and verification procedures, said customer will provide said IP supplier with the hardware program codes corresponding to said design level.

9. The method used for digital right management of system-on-chip (SOC) IP by making use of a system platform as claimed in claim 6, wherein in case that said design level is said physical design level or said logic design level, then upon finishing the simulation and verification procedures, said customer will transmit the layout corresponding to said design level to a chip manufacturer for realizing the layout in the actual physical wiring, and said IP supplier will transmit said decoded IP codes to said chip manufacture, thus realizing the actual physical wiring of the chip.
